(19) United States
(12) Patent Application Publication
(10) Pub. No.: US 2004/0001392 A1
(43) Pub. Date: Jan. 1, 2004

(54) Flash memory-disk watch

(76) Inventor: Yi Shing Chung, Hong Kong (HK)

Correspondence Address: NATH & ASSOCIATES, 1030 15th STREET, 6TH FLOOR, WASHINGTON, DC, 20005, US

(21) Appl. No.: 10/384,738

(22) Filed: Mar. 11, 2003

(30) Foreign Application Priority Data
Jun. 27, 2002 (CN) 02238276.3

(51) Int. Cl. G04B 37/00; G04B 37/12

(52) U.S. Cl. 368/278

(57) ABSTRACT

A flash memory-disk watch comprising a clock work, a dial plate, pointers, and a watchcase having a bottom cover, a case body, a fixing ring and a glass watch cover. A flash memory disk is disposed under the clock work in the watchcase with the USU interface of the flash memory disk inserted in the side of the watchcase. By comparison with the conventional watch, the flash memory-disk watch according to the present utility model not only has the functions of a watch, but also ably integrates all of the functions of the same type of flash memory disk, so that it is a pioneer product in the watch industry.

### THE TECHNICAL FIELD

The present utility model relates to a watch with the flash memory-disk.

### THE BACKGROUND ART

It is well known that a floppy drive and a floppy disk which provide a platform for transferring storage and interchange of data are developed to meet the requirement for portably handling official business. With the advancement of the information technology, the USB flash memory disk is developed timely which is capable of storing data safely, accessing rapid and having a long life. However, almost all of the present flash memory disks have a common disadvantage in that it is inconvenient for carrying and has simplex function. At the same time, since the consuming concept has changed greatly, more and more multiple-function watches are developed in the watch industry, but the common multiple-function watch is just a combination of general electric products with low technical contents.

### THE INVENTIVE CONTENT

In order to overcome the above disadvantages in the prior art, the object of the present utility model is to provide a flash memory-disk watch which not only has the functions of a watch, but also ably integrates all of the functions of the same type of flash memory disk.

In order to achieve the above object, the present utility model provides a flash memory-disk watch comprising a clock work, a dial plate, pointers, and a watchcase having a bottom cover, a case body, a fixing ring and a glass watch cover. A flash memory disk is disposed under the clock work in the watchcase with the USU interface of the flash memory disk inserted in the side of the watchcase.

The clock work is provided at the bottom thereof with a cover capable of fixing the clock work. The cover is made of rubber, plastic and the like and is attached to the watchcase.

The flash memory disk is provided with an indicator light under a viewing hole provided in the dial plate.

The present utility model has advantages in that since a flash memory disk is provided in a conventional watch, the watch according to the present utility model not only has the functions of a watch, but also ably integrates all of the functions of the same type of flash memory disk, adapted to the development of the IT industry and is one of the pioneers who successfully introduce the conventional watch into the IT product.

### THE SPECIFICATION OF THE DRAWINGS

FIG. 1 is a schematic view showing the structure of the flash memory-disk watch according to the present utility model;

FIG. 2 is a plan view showing the structure of the flash memory-disk watch according to the present utility model.

### THE PREFERRED EMBODIMENTS

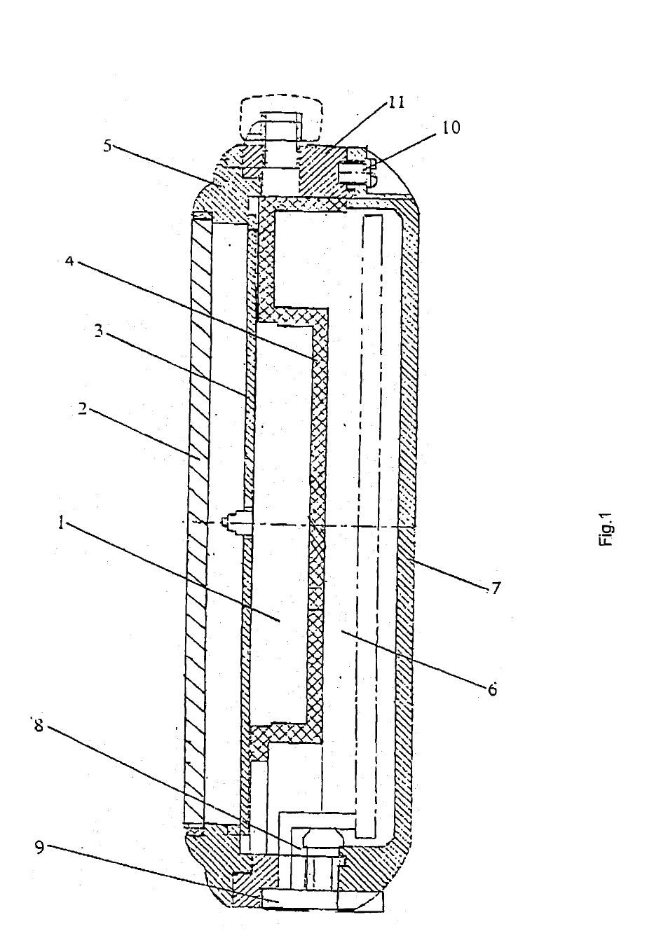

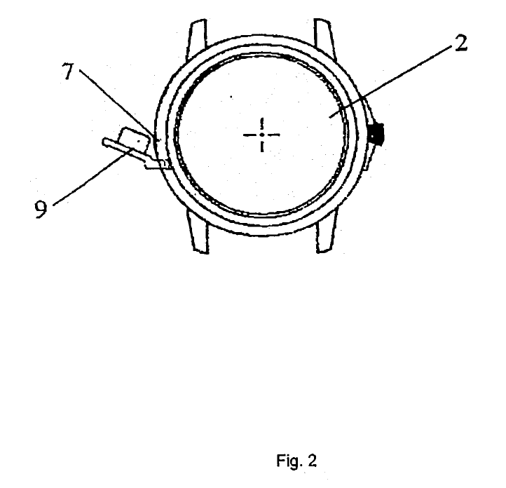

As shown in the FIGS. 1 and 2, the flash memory-disk watch according to the present utility model comprise a clock work 1, a dial plate 3, pointers, a watchcase having a bottom cover 7, a case body 11, a fixing ring 5 and a glass watch cover 2. A flash memory disk 6 is disposed under the clock work 1 in the watchcase. The clock work is provided at the bottom thereof with a cover 4 made of rubber, plastic and the like and attached to the watchcase. The clock work 1 is fixed through the cover 4. The bottom cover 7 is attached to the case body 11 by at least one fixing screw 10. The fixing ring 5 is fitted in the case body 11 with interference fit. The flash memory disk 6 has a USU interface 8 inserted in any side of the watchcase so as to communicate with an apparatus such as a desktop computer, a portable computer and the like. The flash memory disk 6 is provided with an indicator light under a viewing hole provided in the dial plate 3. The user can operate the flash memory disk 6 by viewing the indicator light. In order to protect the USB interface 8 of the flash memory disk 6, a rotatable dust-preventing cover 9 fitted with the USB interface 8 is fixed on the bottom cover 7 of the watchcase.

The flash memory-disk watch according to the present utility model may be a conventional quartz watch or a mechanical watch or the like.

1. A flash memory-disk watch comprising a clock work, a dial plate, pointers, and a watchcase having a bottom cover, a case body, a fixing ring and a glass watch cover is characterized in that a flash memory disk is disposed under the clock work in the watchcase with the USU interface of the flash memory disk inserted in the side of the watchcase.

2. The flash memory-disk watch as claimed in the claim 1 is characterized in that the clock work is provided at the bottom thereof with a cover which is capable of fixing the clock work and which is attached to the watchcase.

3. The flash memory-disk watch as claimed in the claim 1 or 2 is characterized in that the bottom cover is attached to the case body by at least one fixing screw, the fixing ring is fitted in the case body.

4. The flash memory-disk watch as claimed in the claim 1 is characterized in that the flash memory disk is provided with an indicator light under a viewing hole provided in the dial plate.

5. The flash memory-disk watch as claimed in the claim 1 is characterized in that a dust-preventing cover fitted with the USB interface of the flash memory disk is fixed at one end thereof to the watchcase.
